(19) United States
(12) Patent Application Publication
(10) Pub. No.: US 2023/0103968 A1
(43) Pub. Date: Apr. 6, 2023

(54) CATHODE ACTIVE MATERIAL FOR LITHIUM SECONDARY BATTERY AND LITHIUM SECONDARY BATTERY INCLUDING THE SAME

(71) Applicants: SK ON CO., LTD., Seoul (KR); SK INNOVATION CO., LTD., Seoul (KR)

(72) Inventors: Mi Jung NOH, Daejeon (KR); Jae Ho CHOI, Daejeon (KR); Jeong Bae YOON, Daejeon (KR); Sang Bok Kim, Daejeon (KR)

(21) Appl. No.: 18/074,287

(22) Filed: Dec. 2, 2022

(30) Foreign Application Priority Data
Oct. 5, 2021 (KR) 10-2021-0131639

(51) Int. Cl. H01M 4/525; H01M 4/505; C01G 53/00

(52) U.S. Cl. CPC H01M 4/525; H01M 4/505; C01G 53/44; H01M 2004/028

(57) ABSTRACT

A cathode active material for a lithium secondary battery comprises a lithium metal oxide that has a layered crystal structure and contains nickel and aluminum. The lithium metal oxide contains 70 mol % or more of nickel based on a total number of moles of all elements excluding lithium and oxygen. A ratio of lithium sites occupied by nickel instead of lithium among all lithium sites in the lithium metal oxide is in a range from 1% to 3.5%. A weight ratio of aluminum to nickel in the lithium metal oxide is in a range from 1/550 to 1/100.

### CROSS-REFERENCE TO RELATED APPLICATION

This application claims priority to Korean Patent Application No. 10-2021-0131639 filed on Oct. 5, 2021 in the Korean Intellectual Property Office (KIPO), the entire disclosure of which is incorporated by reference herein.

### BACKGROUND

### 1. Field

The present invention relates to a cathode active material for a lithium secondary battery and a lithium secondary battery including the same. More particularly, the present invention relates to a cathode active material including a lithium metal oxide that contains a doping element and a lithium secondary battery including the same.

### 2. Description of the Related Art

A secondary battery which can be charged and discharged repeatedly has been widely employed as a power source of a mobile electronic device such as a camcorder, a mobile phone, a laptop computer, etc.

The secondary battery includes, e.g., a lithium secondary battery, a nickel-cadmium battery, a nickel-hydrogen battery, etc. The lithium secondary battery is highlighted due to high operational voltage and energy density per unit weight, a high charging rate, a compact dimension, etc.

The cathode of the lithium secondary battery includes a cathode active material capable of reversible insertion and de-intercalation of lithium ions. For example, the cathode active material may include a lithium metal oxide. The lithium metal oxide may further include a metal element such as nickel, cobalt, manganese, etc.

Developments of a high nickel-based lithium metal oxide having an increased nickel content and a cathode active material including the same are progressed to achieve a high capacity.

However, the high nickel-based lithium metal oxide may have a degraded chemical stability. For example, Korean Published Patent Application No. 10-2019-0078498 discloses a high nickel-based lithium metal oxide with improved chemical stability.

### SUMMARY

According to an aspect of the present invention, there is provided a cathode active material for a lithium secondary battery having improved chemical stability and high capacity.

According to an aspect of the present invention, there is provided a lithium secondary battery including a cathode active material with improved chemical stability and high capacity.

A cathode active material for a lithium secondary battery includes a lithium metal oxide that has a layered crystal structure and contains nickel and aluminum. The lithium metal oxide contains 70 mol % or more of nickel based on a total number of moles of all elements excluding lithium and oxygen A ratio of lithium sites occupied by nickel instead of lithium among all lithium sites in the lithium metal oxide is in a range from 1% to 3.5%. A weight ratio of aluminum to nickel in the lithium metal oxide is in a range from 1/550 to 1/100.

In some embodiments, the lithium metal oxide may contain 80 mol % or more of nickel based on the total number of moles of all elements excluding lithium and oxygen.

In some embodiments, the ratio of the lithium sites occupied by nickel instead of lithium among all lithium sites in the lithium metal oxide may be in a range from 1% to 1.5%.

In some embodiments, the weight ratio of aluminum to nickel in the lithium metal oxide may be in a range from 1/300 to 1/150.

In some embodiments, the lithium metal oxide may be represented by Chemical Formula 1 below.

LiₐNiₓAl_{y}M_{1-x-y}O_{z} [Chemical Formula 1]

In Chemical Formula 1, M may include at least one of Co, Mn, Zr, Ti, Cr, B, Mg, Ba, Si, Y, W, La and Sr, 0.9<a≤1.2, 0.7≤x≤0.99, and 2≤z≤2.02, y is a value satisfying the weight ratio of aluminum to nickel.

In some embodiments, M in Chemical Formula 1 may include at least one of Co, Mn, Ti and Zr.

In some embodiments, the ratio of the lithium sites occupied by nickel instead of lithium among all lithium sites may obtained by an X-ray diffraction and a Rietveld refinement.

In some embodiments, the lithium metal oxide may have a secondary particle structure in which primary particles are aggregated, and a crystallite size of a (104) plane of the primary particles may be 150 nm or less.

A lithium secondary battery includes a cathode comprising the cathode active material for a secondary battery according to the above-described embodiments, and an anode facing the cathode.

The cathode active material for a secondary battery according to exemplary embodiments includes a lithium metal oxide containing nickel and aluminum to suppress a cation mixing. Accordingly, the cathode active material may have improved chemical stability (e.g., high temperature stability) and enhanced charge/discharge efficiency.

### BRIEF DESCRIPTION OF THE DRAWINGS

FIGS. 1 and 2 are a schematic plan view and a cross-sectional view, respectively, of a lithium secondary battery in accordance with exemplary embodiments.

### DETAILED DESCRIPTION OF THE EMBODIMENTS

<Cathode Active Material>

A cathode active material for a secondary battery according to exemplary embodiments may include a layered crystalline structure, and may include a lithium metal oxide containing nickel and aluminum.

In an embodiment, the lithium metal oxide may include nickel in 70 mol % or more based on the total number of moles of all elements excluding lithium and oxygen.

In some embodiments, the lithium metal oxide may include 80 mol % or more, 83 mol % or more, 85 mol % or more, or 90 mol % or more of nickel based on the total number of moles of all elements excluding lithium and oxygen. In this case, a secondary battery having a higher capacity may be implemented.

For example, a layered lithium metal oxide having the layered crystalline structure may include a lithium layer and a metal layer in a crystal structure thereof.

For example, in the layered lithium metal oxide containing nickel, nickel present in the metal layer may be mixed into the lithium layer during a high-temperature calcination to occupy a original lithium site.

For example, a deficiency in the lithium site of the lithium layer may occur during the high-temperature calcination, and nickel may occupy a vacant site in which the deficiency occurs. For example, lithium at some of the lithium sites where lithium should be originally located in the layered crystal structure of the lithium metal oxide may be substituted with nickel, and thus nickel may be present at the corresponding site.

In an embodiment, in the lithium metal oxide, a ratio of lithium sites occupied by nickel instead of lithium among all lithium sites (hereinafter, referred to R value) may be in a range from 1% to 3.5%. Preferably, the R value may be in a range from 1% to 1.5%. In the range of the R value, the secondary battery having more improved charge/discharge efficiency and high temperature stability may be achieved.

For example, if the R value is less than 1%, the charging/discharging efficiency and high temperature stability of the secondary battery may be degraded. If the R value exceeds 3.5%, the charging/discharge efficiency and high temperature stability of the secondary battery may also be degraded.

For example, the R value may be obtained through an X-ray diffraction (XRD) and a Rietveld refinement. Accordingly, a more accurate crystallographic analysis result may be obtained than that obtained by a conventional X-ray diffraction quantitative analysis method only using the XRD.

For example, the Rietveld refinement method can analyze an entire diffraction pattern at once without a need to separate peaks in an X-ray diffraction pattern measured according to the XRD for the lithium metal oxide. Accordingly, the analysis by the Rietveld refinement method may provide more accurate crystallographic analysis results. Thus, difference in chemical properties resulting from a composition and a crystal structure of the lithium metal oxide may be measured and confirmed more precisely.

For example, the Rietveld refinement method may be performed using a High score plus program and a pseudo-Voight function model. However, the program used in the Rietveld refinement method may not be particularly limited.

For example, the lithium metal oxide may include aluminum as a doping element. For example, when aluminum is doped into the lithium metal oxide, a bond length between the metal layer and oxygen (O) may become small.

In an embodiment, a ratio of a weight of aluminum relative to a weight of nickel in the lithium metal oxide may be in a range from 1/550 to 1/100. Preferably, the ratio of the weight of aluminum relative to the weight of nickel in the lithium metal oxide may be in a range from 1/300 to 1/150. In the above range, the secondary battery having more improved charge/discharge efficiency and high temperature stability may be implemented.

For example, if the weight ratio of nickel and aluminum exceeds 1/100, nickel in the metal layer may more easily move to the lithium layer to occupy the lithium sites. Accordingly, nickel may interfere with movement of lithium ions during charging and discharging of the secondary battery, thereby degrading charging/discharge efficiency. If the weight ratio of nickel and aluminum is less than 1/550, the high temperature stability of the lithium metal oxide may be reduced.

In the lithium metal oxide according to exemplary embodiments, the R value and the weight ratio of nickel and aluminum may be adjusted to the above-described range, thereby providing the lithium secondary battery having improved charge/discharge efficiency and high temperature stability.

In an embodiment, the lithium metal oxide may have a structure of secondary particles in which primary particles are aggregated.

In some embodiments, the primary particle may have a crystallographically polycrystalline structure.

In an embodiment, the lithium metal oxide may be represented by Chemical Formula 1 below.

LiₐNiₓAl_{y}M_{1-x-y}O_{z} [Chemical Formula 1]

In Chemical Formula 1, M may include at least one element selected from Co, Mn, Zr, Ti, Cr, B, Mg, Ba, Si, Y, W, La and Sr, 0.9<a≤1.2, 0.7≤x≤0.99, and 2≤z≤2.02.

For example, y may be adjusted to satisfy the above-described weight ratio of nickel and aluminum. For example, 0.002≤y≤0.025, preferably, 0.005≤y≤0.015.

In some embodiments, 0.8≤x<1, 0.83≤x<1, 0.85≤x<1, or 0.90≤x<1.

In some embodiments, 0.8≤x≤0.99, 0.83≤x≤0.99 0.85≤x≤0.99, or 0.90≤x≤0.99.

In some embodiments, in Chemical Formula 1, M may include at least one of Co, Mn, Ti and Zr.

In some embodiments, M may include at least one of Co and Mn.

In some embodiments, M may include Co and Mn.

In some embodiments, the lithium metal oxide may include a polycrystalline structure, and a crystallite size of a (104) plane may be 150 nm or less, or 100 nm or less. In this case, the secondary battery having more improved high-temperature stability may be implemented.

In an embodiment, the lithium metal oxide may further include a coating metal or a coating metalloid on a surface of the lithium metal oxide. For example, the coating metal or the coating metalloid may include Al, Ti, Ba, Zr, Si, B, Mg, P, Sr, W, La, an alloy thereof, or an oxide thereof. These may be used alone or in combination thereof.

<Lithium Secondary Battery>

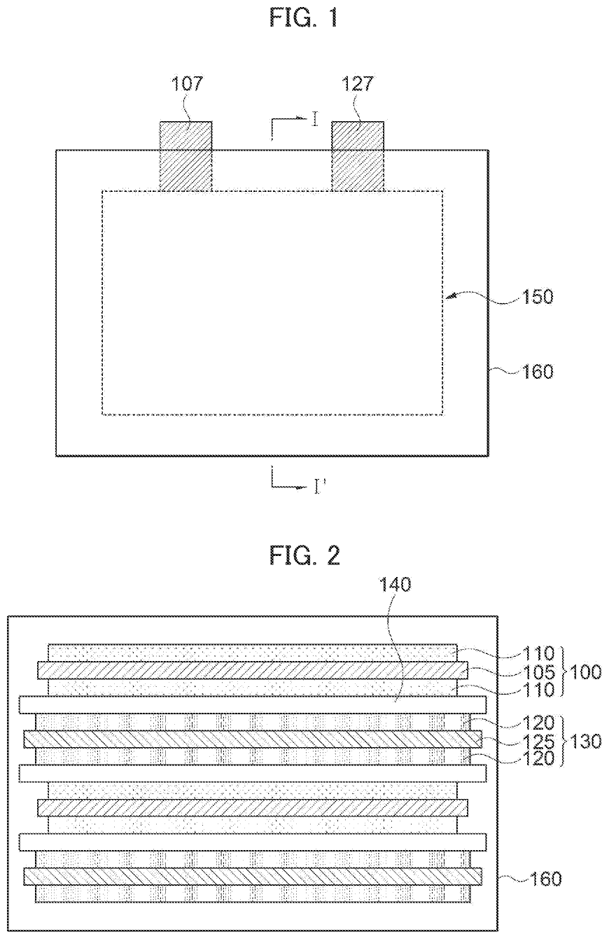

FIGS. 1 and 2 are a schematic plan view and a cross-sectional view, respectively, of a lithium secondary battery in accordance with exemplary embodiments.

FIG. 2 is a cross-sectional view taken along a line I-I′ of FIG. 1.

Referring to FIGS. 1 and 2, a lithium secondary battery may include a cathode 130 and an anode 140. For example, the cathode 130 and the anode 140 may face each other.

The cathode 130 may include a cathode current collector 105 and a cathode active material layer 110 on the cathode current collector 105.

For example, the cathode active material layer 110 includes a cathode active material, and may further include a cathode binder and a conductive material. For example, the cathode active material according to the above-described exemplary embodiments may be employed as the cathode active material.

For example, a cathode slurry may be prepared by mixing and stirring the cathode active material, the cathode binder, the conductive material, a dispersive agent, etc. The cathode slurry may be coated on the cathode current collector 105, and dried and pressed to from the cathode 100.

The cathode current collector 105 may include stainless-steel, nickel, aluminum, titanium, copper or an alloy thereof. Preferably, aluminum or an alloy thereof may be used.

The cathode binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The anode 130 may include an anode current collector 125 and an anode active material layer 120 on the anode current collector 125.

For example, the anode active material layer 120 includes an anode active material, and may further include an anode binder and a conductive material.

For example, an anode slurry may be prepared by mixing and stirring the anode active material, the anode binder, the conductive material, a dispersive agent, etc. The anode slurry may be coated on the anode current collector 125, and dried and pressed to form the anode 130.

The anode current collector 125 may include, e.g., gold, stainless steel, nickel, aluminum, titanium, copper or an alloy thereof, preferably may include copper or a copper alloy.

The anode active material may include a material which may be capable of adsorbing and ejecting lithium ions. For example, the anode active material may include a carbon-based material such as a crystalline carbon, an amorphous carbon, a carbon complex or a carbon fiber, a lithium alloy, silicon (Si)-based compound, etc.

The amorphous carbon may include a hard carbon, cokes, a mesocarbon microbead (MCMB) fired at a temperature of 1500° C. or less, a mesophase pitch-based carbon fiber (MPCF), etc.

The crystalline carbon may include a graphite-based material such as natural graphite, graphitized cokes, graphitized MCMB, graphitized MPCF, etc.

For example, the silicon-based active material may include Si, SiOx (0<x<2), Si/C, SiO/C, Si-Metal, etc.

The lithium alloy may further include aluminum, zinc, bismuth, cadmium, antimony, silicon, lead, tin, gallium, indium, etc.

The anode binder and the conductive material substantially the same as or similar to those used for forming the cathode 100 may also be used. In some embodiments, the anode binder may include, e.g., styrene-butadiene rubber (SBR) or an acrylic binder for compatibility with the carbon-based active material, and carboxymethyl cellulose (CMC) may also be used as a thickener.

In an embodiment, a separation layer 140 may be interposed between the anode 100 and the cathode 130.

In some embodiments, an area of the anode 130 (e.g., a contact area with the separation layer 140) may be greater than that of the cathode 100. Thus, lithium ions generated from the cathode 100 may be easily transferred to the anode 130 without a loss by, e.g., precipitation or sedimentation.

The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like.

The separation layer 140 may also include a non-woven fabric formed from a glass fiber with a high melting point, a polyethylene terephthalate fiber, or the like.

For example, an electrode cell may be defined by the cathode 100, the anode 130 and the separation layer 140, and a plurality of the electrode cells may be stacked to form an electrode assembly. For example, the electrode assembly 150 may be formed by winding, laminating or folding the separation layer 140.

As illustrated in FIG. 1, the lithium secondary battery according to exemplary embodiments may include a cathode lead 107 connected to the cathode 100 to protrude to an outside of a case 160, and an anode lead 127 connected to the anode 130 to protrude to the outside of the case 160.

For example, the cathode lead 107 may be electrically connected to the cathode current collector 105. The anode lead 130 may be electrically connected to the anode current collector 125.

For example, the cathode current collector 105 may include a protrusion (a cathode tab, not illustrated) at one side thereof. The cathode active material layer 110 may not be formed on the cathode tab. The cathode tab may be integral with the cathode current collector 105 or may be connected to the cathode current collector 105 by, e.g., welding. The cathode current collector 105 and the cathode lead 107 may be electrically connected via the cathode tab.

The anode current collector 125 may include a protrusion (an anode tab, not illustrated) at one side thereof. The anode active material layer 120 may not be formed on the anode tab. The anode tab may be integral with the anode current collector 125 or may be connected to the anode current collector 125 by, e.g., welding. The anode electrode current collector 125 and the anode lead 127 may be electrically connected via the anode tab.

In an embodiment, the electrode assembly 150 may include a plurality of the cathodes and a plurality of the anodes. For example, the cathode and the anode may be alternately arranged, and the separation layer may be interposed between the cathode and the anode. Accordingly, the lithium secondary battery according to an embodiment of the present invention may include a plurality of the cathode tabs and a plurality of the anode tabs protruding from the plurality of the cathodes and the plurality of the anodes, respectively.

In an embodiment, the cathode tabs (or the anode tabs) may be laminated, compressed or welded to form a cathode tab stack (or an anode tab stack). The cathode tab stack may be electrically connected to the cathode lead 107, and the anode tab stack may be electrically connected to the anode lead 127.

For example, the electrode assembly may be accommodated together with an electrolyte in the case 160 to form a lithium secondary battery.

For example, the electrolyte may include a lithium salt, and an organic solvent optionally with an additive.

For example, the lithium salt may be expressed as Li⁺X⁻. The anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc. In some embodiments, the lithium salt may include at least one of LiBF₄ and LiPF₆.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination thereof.

For example, the additive may include a fluorine-containing carbonate-based compound, a vinylidene carbonate-based compound, a fluorine-containing lithium phosphate-based compound, a sultone-based compound, a sulfate-based compound, a borate-based compound, a nitrile-based compound, an amine-based compound, a silane-based compound, a benzene-based compound, etc. These may be used alone or in a combination thereof.

For example, the fluorine-containing carbonate-based compound may include fluoroethylene carbonate (FEC).

For example, the vinylidene carbonate-based compound may include at least one of vinylene carbonate (VC) and vinylethylene carbonate (VEC).

For example, the fluorine-containing lithium phosphate-based compound may include at least one of lithium difluoro phosphate (LiPO₂F₂) and lithium difluoro (bisoxalato) phosphate.

For example, the sultone-based compound may include at least one of 1,3-propane sultone (PS), 1,4-butane sultone, ethenesultone, 1,3-propene sultone (PRS), 1,4-butene sultone and 1-methyl-1,3-propene sultone.

For example, the sulfate-based compound may include at least one of ethylene sulfate (ESA), trimethylene sulfate (TMS) and methyltrimethylene sulfate (MTMS).

For example, the borate-based compound may include at least one of lithium tetraphenyl borate and lithium difluoro(oxalato)borate (LiODFB).

For example, the nitrile-based compound may include at least one of succinonitrile, adiponitrile, acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile and 4-fluorophenylacetonitrile.

For example, the amine-based compound may include at least one of triethanolamine and ethylene diamine.

For example, the silane-based compound may include tetravinyl silane.

For example, the benzene-based compound may include at least one of monofluorobenzene, difluorobenzene, trifluorobenzene, and tetrafluorobenzene.

The lithium secondary battery may be manufactured in, e.g., a cylindrical shape using a can, a square shape, a pouch shape or a coin shape.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Examples and Comparative Examples

(1) Preparation of Lithium Metal Oxide

NiSO₄, CoSO₄ and MnSO₄ were mixed in a molar ratio of 8:1:1, respectively using distilled water from which dissolved oxygen was removed by bubbling with N₂ for 24 hours to from a reaction solution.

The reaction solution was put into a continuous stirred-tank reactor (CSTR) at 50° C., and NaOH and NH₃H₂O were used as a precipitating agent and a chelating agent, respectively, to proceed with a co-precipitation reaction for 30 hours to obtain a metal hydroxide.

The metal hydroxide was dried at 80° C. for 12 hours and then re-dried at 110° C. for 12 hours.

The metal hydroxide, LiOH and Al(OH)₃ were mixed to prepare a precursor mixture. A mixed amount of LiOH was adjusted so that a molar ratio of the metal hydroxide and LiOH became 1:1.03. A mixed amount of Al(OH)₃ was adjusted so that a weight ratio of Ni and Al in a prepared lithium metal oxide satisfied a ratio as shown in Table 1 below.

The precursor mixture was placed in a kiln, heated to 780° C. at a rate of 2° C./min, and maintained at 780° C. for 10 hours. While elevating and maintaining the temperature, an oxygen gas was continuously passed through at a flow rate of 10 mL/min.

After the calcination, natural cooling to room temperature, pulverization and classification were performed to obtain lithium metal oxides of Examples and Comparative Examples.

(2) Fabrication of Secondary Battery

The lithium metal oxides of Examples and Comparative Examples, carbon black and PVDF were dispersed in NMP in a weight ratio of 92:5:3 to prepare a cathode slurry.

An aluminum foil (thickness: 15 μm) having a protrusion (a cathode tab) at one side thereof was prepared. A cathode was manufactured by uniformly coating, drying and pressing the cathode slurry on an area of the aluminum foil except for the protrusion.

An anode slurry was prepared by dispersing an anode active material in which artificial graphite and natural graphite were mixed in a weight ratio of 7:3, SBR and carboxymethyl cellulose (CMC) in water by a weight ratio of 97:1:2.

A copper foil (15 μm) having a protrusion (an anode tab) at one side thereof was prepared. The anode slurry was uniformly coated on an area of the copper foil except for the protrusion, dried and pressed to prepare an anode.

A polyethylene separation layer (thickness: 20 μm) was interposed between the cathode and the anode to form an electrode assembly. Thereafter, a cathode lead and an anode lead were welded and connected to the cathode tab and the anode tab, respectively.

The electrode assembly was accommodated in a pouch (case) so that portions of the cathode lead and the anode lead were exposed to an outside, and three sides except for an electrolyte injection side were sealed.

After injecting an electrolyte and sealing the electrolyte injection side, a lithium secondary battery sample was prepared by an immersion for 12 hours.

As the electrolyte, a 1M LiPF₆ solution (in a mixed solvent of EC/EMC/DEC by a volume ratio of 25:30:45) was prepared. Further, 1 wt % of FEC (fluoroethylene carbonate), 0.3 wt % of VC (vinylethylene carbonate), 1.0 wt % of LiPO₂F₂ (lithium difluorophosphate) 1.0 wt %, 0.5 wt % of PS (1,3-propane sultone) and 0.5 wt % of PRS (prop-1-ene-1,3-sultone) were added based on a total weight of the electrolyte.

### Experimental Example 1

(1) Measurement of Weight Ratio of Al to Ni in Lithium Metal Oxide

The lithium metal oxides of Examples and Comparative Examples were completely dissolved in 40 ml of hydrochloric acid (2%) for 3 hours. After diluting the solution about 10 times, elements contained in the entire solution were detected by an inductively coupled plasma-optical emission spectroscopy (ICP-OES; Optima 7300DV, PerkinElmer).

Based on the detection results, the weight ratio of Al:Ni was calculated.

(2) Measurement of Ratio of Ni Occupying Li Site (Hereinafter, R Value)

For the lithium metal oxides of Examples and Comparative Examples, a ratio of lithium sites occupied by nickel instead of lithium among all lithium sites was measured.

Specifically, the R value was derived by an X-ray diffraction (XRD) and a Rietveld refinement, and detailed conditions were as follows.

i) XRD Measurement Conditions

Equipment: PANalytical EMPYREAN

Specification: Power 4 kW

OPTIC: Bragg-Brentano HD, PIXcel3D Detector

range: 10° to 120°

Step size: 0.00625°

Scan speed: 0.98°/min

Wavelength: Cu Ka 1,560

ii) Rietveld refinement method conditions

Program: High score plus

Model: pseudo-Voigt function

### Experimental Example 2: Evaluation on Initial Property

The lithium secondary batteries of Examples and Comparative Examples were charged at 25° C. under condition of 0.5 C CC/CV (4.2V, 0.05 C CUT-OFF) to measure an initial charge capacity C1.

The charged lithium secondary battery was discharged under conditions of 0.5 C CC (2.7V CUT-OFF) to measure an initial discharge capacity D1.

An initial efficiency was calculated as follows.

Initial efficiency (%)=D1/C1×100(%)

### Experimental Example 3: Evaluation on High-Temperature Storage Property (Capacity Retention after High-Temperature Storage)

The lithium secondary batteries of Examples and Comparative Examples were charged under conditions of 0.5 C CC/CV (4.2V 0.05 C CUT-OFF).

The charged lithium secondary batteries were stored at 60° C. for 5 weeks (using a constant temperature apparatus), left for additional 30 minutes at room temperature, and then 0.5 C CC discharged (2.75 V CUT-OFF) to measure a discharge capacity D2.

A capacity retention after high temperature storage was calculated as follows.

Capacity retention after high temperature storage (%)=D2/D1×100(%)

The evaluation results are shown in Table 1 below.

TABLE 1

| | | | | | | capacity |
|---|---|---|---|---|---|---|
| | | | | | | retention |
| | | | | | | after high |
| | | | initial property | | | temper- |
| | R | Al:Ni | charge | discharge | effi- | ature |
| | value | weight | capacity | capacity | ciency | storage |
| | (%) | ratio | (mAh) | (mAh) | (%) | (%) |
| Example 1 | 1.04 | 1:532 | 241.0 | 219.7 | 91 | 89.2 |
| Example 2 | 1.25 | 1:244 | 241.9 | 220.3 | 91 | 90.4 |
| Example 3 | 2.45 | 1:134 | 241.7 | 218.1 | 90 | 88.8 |
| Comparative | 0.92 | 1:7326 | 241.5 | 219.5 | 91 | 82.1 |
| Example 1 | | | | | | |
| Comparative | 0.98 | 1:317 | 236.9 | 210.9 | 85 | 82.8 |
| Example 2 | | | | | | |
| Comparative | 3.80 | 1:219 | 232.9 | 181.9 | 78 | 84.9 |
| Example 3 | | | | | | |
| Comparative | 2.80 | 1:5130 | 241.0 | 212.7 | 88 | 72.3 |
| Example 4 | | | | | | |

Referring to Table 1 above, the R value of the lithium metal oxide and the weight ratio of aluminum to nickel in the lithium metal oxide were adjusted within specific numerical ranges (e.g., the R value: 1% to 3.5%, the weight ratio of Al to Ni:1/550 to 1/100), so that the enhanced initial property and high temperature stability of the secondary battery were achieved.

In Comparative Example 1 where the lithium metal oxide in which both the R value and the weight ratio of Al to Ni were not within the above-mentioned numerical range was used, degraded high-temperature storage property was obtained.

In Comparative Examples 2 and 3 where the lithium metal oxide in which the weight ratio of Al to Ni was within the aforementioned numerical range, but the R value was not within the aforementioned numerical range was used, the initial efficiency and the high-temperature storage property were all deteriorated.

In Comparative Example 4 where the lithium metal oxide in which the R value was within the aforementioned numerical range, but the weight ratio of Al to Ni was not within the aforementioned numerical range was used, the high-temperature storage property was deteriorated.

What is claimed is:

1. A cathode active material for a lithium secondary battery comprising a lithium metal oxide that has a layered crystal structure and contains nickel and aluminum,
wherein the lithium metal oxide contains 70 mol % or more of nickel based on a total number of moles of all elements excluding lithium and oxygen,
a ratio of lithium sites occupied by nickel instead of lithium among all lithium sites in the lithium metal oxide is in a range from 1% to 3.5%, and
a weight ratio of aluminum to nickel in the lithium metal oxide is in a range from 1/550 to 1/100.

2. The cathode active material for a secondary battery of claim 1, wherein the lithium metal oxide contains 80 mol % or more of nickel based on the total number of moles of all elements excluding lithium and oxygen.

3. The cathode active material for a secondary battery of claim 1, wherein the ratio of the lithium sites occupied by nickel instead of lithium among all lithium sites in the lithium metal oxide is in a range from 1% to 1.5%.

4. The cathode active material for a secondary battery of claim 1, wherein weight ratio of aluminum to nickel in the lithium metal oxide is in a range from 1/300 to 1/150.

5. The cathode active material for a secondary battery of claim 1, wherein the lithium metal oxide is represented by Chemical Formula 1:
LiₐNiₓAl_{y}M_{1-x-y}O_{z} [Chemical Formula 1]
wherein, in Chemical Formula 1, M includes at least one of Co, Mn, Zr, Ti, Cr, B, Mg, Ba, Si, Y, W, La and Sr, 0.9<a≤1.2, 0.7≤x≤0.99, 2≤z≤2.02, and y is a value satisfying the weight ratio of aluminum to nickel.

6. The cathode active material for a secondary battery of claim 5, wherein M in Chemical Formula 1 includes at least one of Co, Mn, Ti and Zr.

7. The cathode active material for a secondary battery of claim 1, wherein the ratio of the lithium sites occupied by nickel instead of lithium among all lithium sites is obtained by an X-ray diffraction and a Rietveld refinement.

8. The cathode active material for a secondary battery of claim 1, wherein the lithium metal oxide has a secondary particle structure in which primary particles are aggregated, and a crystallite size of a (104) plane of the primary particles is 150 nm or less.

9. A lithium secondary battery, comprising:
a cathode comprising the cathode active material for a secondary battery according to claim 1; and
an anode facing the cathode.
